(19) United States
(12) Patent Application Publication
(10) Pub. No.: US 2026/0024947 A1
(43) Pub. Date: Jan. 22, 2026

(54) ELECTRICAL CONNECTOR ASSEMBLY

(71) Applicant: STÄUBLI ELECTRICAL CONNECTORS AG, Allschwil (CH)

(72) Inventors: Dustin Delmar Reede CARVER, Windsor, CA (US); Max KATZ, San Jose, CA (US); Grayson MAURER, Grass Valley, CA (US); Brian Wade MILLS, Santa Rosa, CA (US); Lee Michael WADE, Windsor, CA (US); Andrew HOWARD, Windsor, CA (US)

(73) Assignee: STÄUBLI ELECTRICAL CONNECTORS AG, Allschwil (CH)

(21) Appl. No.: 19/111,859

(22) PCT Filed: Sep. 5, 2023
(86) PCT No.: PCT/EP2023/074230

§ 371 Date: Mar. 14, 2025

Related U.S. Application Data
(60) Provisional application No. 63/406,944, filed on Sep. 15, 2022.
(60) Provisional application No. 63/406,934, filed on Sep. 15, 2022.
(60) Provisional application No. 63/406,939, filed on Sep. 15, 2022.

(51) Int. Cl. H01R 13/64; H01R 13/627

(52) U.S. Cl. CPC H01R 13/64; H01R 13/6271

(57) ABSTRACT

An electrical connector assembly having a first housing having a first connection portion, and a second housing having a second connection portion. The first housing is connected with the second housing, the first connection portion and the second connection portion engage with each other. The first housing has further a first coding ring with a first coding element, wherein the position of the first coding ring regarding to the first housing can be adjusted in at least two determined positions. The second housing has further a second coding ring with a second coding element, wherein the position of the second coding ring regarding to the second housing can be adjusted in at least two determined positions. The first housing and the second housing are connectable only when the first coding ring and the second coding ring are located at the same determined position.

### TECHNICAL FIELD

The present invention relates to an electrical connector assembly according to claim 1.

### PRIOR ART

Electrical connector assemblies are known from prior art. Many of such electrical connector assemblies comprise coding elements for prevent incorrect connection. For example, a coding element may be arranged such that two determined connector housings can be connected together. In other examples coding elements may be arranged to prevent a connection with incorrect polarity.

### SUMMARY OF THE INVENTION

It is an object of the present invention to provide an electrical connector assembly with increased modularity with regard to coding options.

This object is solved by the electrical contact element according to claim 1. According to claim 1, an electrical connector assembly comprises a first housing defining a first interior space in which at least one first electrical plug element is arranged and having a first connection portion, and a second housing defining a second interior space in which at least one second electrical plug element is arranged and having a second connection portion.

The first housing is connectable with the second housing along a plug-in direction. When the first housing is connected with the second housing, the first connection portion and the second connection portion engage with each other and an electrical contact is established between said at least one first electrical plug element and said at least one second electrical plug element. The first housing has further a first coding ring with a first coding element, wherein the position of the first coding ring with regard to the first housing can be adjusted in at least two determined positions. Further, the second housing has further a second coding ring with a second coding element, wherein the position of the second coding ring with regard to the second housing can be adjusted in at least two determined positions. The first housing and the second housing are connectable only when the first coding ring and the second coding ring are located at the same determined position and wherein the first coding element engages with the second coding element when the first housing is connected to the second housing.

The first housing and the second housing are not connectable with each when the first coding ring and the second coding ring are not located at the same determined position, or when the first coding ring and the second coding ring are located at the different determined positions, respectively.

With such a structure a connector assembly can be provided which has a modular coding structure that can be set by a user. Therefore, the user simply arranges the first coding ring and the second coding ring in view of the specific user needs.

Preferably the coding ring is provided separately from the respective housing and is mountable to the respective housing at the chosen determined position.

The plug-in direction is preferably a longitudinal direction. Hence, the housings will be moved together along a straight axis.

Preferably, four or five determined positions are possible. In particular, seven positions are provided.

In a first variant said determined positions are provided by means of at least two position grooves into which at least one position notch engages. The number of position grooves in the first variant is preferably equal to the number of determined positions, wherein the number of position notches is preferably lower than the number of grooves. Preferably, exactly one notch is arranged.

In a second variant said determined positions are provided by means of at least two position notches and at least one position groove into which the position notch engages. The number of position notches in the second variant is preferably equal to the number of determined positions, wherein the number of position grooves is preferably lower than the number of notches. Preferably, exactly one groove is arranged. In this embodiment the regions near the position grooves are provided such that notches which are not in engagement with the position groove have respective space.

Preferably, said position groove or position grooves, respectively and said position notch or position notches, respectively, are oriented such that the position notch can be guided into one of said position grooves along a longitudinal movement of the respective coding ring to the respective housing.

Preferably, the longitudinal movement is collinear to the plug-in direction along which the first housing is coupled to the second housing.

In a preferred embodiment said first housing comprises said at least two position grooves and wherein said first coding ring comprises said at least one position notch; and/or wherein said second housing comprises said at least two position grooves and wherein said first coding ring comprises said at least one position notch. Even more preferably the exactly one position notch is arranged on each coding ring.

Preferably, the shape of the position groove and the position notch of the first housing and the first coding ring is different from the shape of the position groove and the position notch of the second housing and the second coding ring.

Therefore, a mismatch, namely the arrangement of the first coding ring on the second housing and vice-versa, during assembly can be prevented.

Preferably said position notch protrudes away from a back face of said coding rings. This has the advantage that the elements which are arranged to position the coding ring do not influence the coupling.

The front face of each coding ring, which faces the other ring, is preferably an even face without any protrusions.

Preferably, said first coding ring is mechanically locked to said first housing and/or wherein said second coding ring is mechanically locked to said second housing.

Preferably, a latching structure is provided to mechanically lock the respective ring to the respective housing.

Preferably said determined positions are marked with a marking. The marking has preferably the shape of a letter and/or a number and/or a symbol and/or a combination thereof. Preferably the marking on the first housing and on the second housing are provided in the same manner.

Preferably, one of said coding rings comprises a coding notch as a respective coding element and wherein the other one of said coding rings comprises a coding groove as a respective coding element into which coding groove said coding notch engages when the first housing is connected to the second housing.

In a first variant first coding element is a coding notch extending from the inner side of said first coding ring into the ringspace of said first coding ring and wherein said second coding element is a coding groove extending from the outer side into said second ring, wherein the coding notch and the coding groove have complementary forms such that the coding notch can be inserted into the coding groove.

In a second variant said first coding element is a coding groove extending from the inner side of said first coding ring into said coding ring and wherein said second coding element is a coding notch extending from the outer side of said second coding ring, wherein the coding notch and the coding groove have complementary forms such that the coding notch can be inserted into the coding groove.

The term ringspace is to be understood as being the space within the ring that is surrounded by a side wall of the ring. The ringspace is preferably a circular cylinder. The face of the side wall facing the ringspace is said inner side and the face of the side wall on the other side of the ringspace is said outer side. The inner side as well as the outer side are provided as circular cylinder apart from the regions where the coding elements are arranged.

Preferably, the second coding ring extends with its outer side into the ringspace of the first coding ring.

Preferably the second coding ring has a circular cylinder surface section. Preferably, said ringspace is provided as circular cylinder. The outer diameter of the circular cylinder surface section of the second coding ring is smaller than the inner diameter of the ringspace such that the circular cylinder surface section can extend into the ringspace.

Preferably, the first housing has a front face and said first coding element is located before the front face as seen in plug-in direction. Preferably, the second housing has a front face and said second coding element is located after the front face as seen in plug-in direction.

Preferably, said first coding ring is mounted to a first mounting section on the first housing, wherein the ringspace of said first coding ring is in contact with said first mounting section. Preferably, said second coding ring is mounted to a second mounting section on the first housing, wherein the ringspace of said second coding ring is in contact with said second mounting section.

Preferably said coding groove and said coding notch are oriented such that the coding notch can be guided into one of said coding groove along the plug-in direction.

Preferably, said first connector housing comprises a further coding element and wherein said second connector housing comprises a further coding element, wherein said further coding elements engage with each other when the first housing is connected the second housing.

With the additional coding element not only the first and the second coding elements must match, but also said additional coding element.

Preferably, one of the coding rings comprise at least one cut through which at least one of said further coding element is guided during a mating process.

Preferably, said first connector housing comprises at least one first latching element and wherein said second connector housing comprises at least one second latching element, wherein said at least one first latching element engages with said at least one second latching element.

Preferably, the at least one first latching element is a latching opening and the at least one second latching element is a latching tongue which engages into said latching opening.

Preferably, said further coding elements are part of the at least one first latching element and/or of the first housing and of the at least one second latching element and/or the second housing.

Preferably, said at least one first electrical plug element is a socket and said at least one second electrical plug element is a pin, wherein the pin engages into the socket. Alternatively, said at least one first electrical plug element is a pin and said at least one second electrical plug element is a socket, wherein the pin engages into the socket.

In a first variant, said at least one first electrical plug element and/or said at least one second electrical plug element are directly mounted within the respective housing. In a second variant, said at least one first electrical plug element and/or said at least one second electrical plug element are mounted with a contact carrier element within the respective housing.

Preferably, the first coding ring and/or the second coding ring are mechanically locked to the first housing or the second housing, respectively. Preferably, latching elements are provided on the housings and/or on the coding rings.

Further embodiments of the invention are laid down in the dependent claims.

### BRIEF DESCRIPTION OF THE DRAWINGS

Preferred embodiments of the invention are described in the following with reference to the drawings, which are for the purpose of illustrating the present preferred embodiments of the invention and not for the purpose of limiting the same. In the drawings,

FIG. 1a shows a preferred embodiment of a connector assembly in a first perspective view;

FIG. 1b shows a preferred embodiment of the connector assembly according to FIG. 1 in a second perspective view;

FIG. 2 shows a top view of the connector assembly with exploded coding rings;

FIG. 3 shows a first perspective and exploded view of a first housing of a connector assembly according to one of the previous figures;

FIG. 4 shows a further perspective and exploded view of the first housing of a connector assembly according to one of the previous figures;

FIG. 5 shows a first perspective and exploded view of a second housing of a connector assembly according to one of the previous figures;

FIG. 6 shows a further perspective and exploded view of the second housing of a connector assembly according to one of the previous figures;

FIG. 7 shows a further perspective and exploded view of the first housing and the second housing of a connector assembly according to one of the previous figures;

FIG. 8 shows a further perspective and exploded view of the first housing and the second housing of a connector assembly according to one of the previous figures;

FIG. 9 shows a cross-sectional view wherein coding elements of the first housing engage with coding elements of the second housing;

FIG. 10 shows a perspective view of the first housing and the second housing before connection,

FIG. 11 shows a perspective view of the first housing and the second housing before connection,

FIG. 12 shows a perspective view of the first housing and the second housing after connection, and

FIG. 13 shows a cross-sectional view wherein coding elements of the first housing engage with coding elements of the second housing.

### DESCRIPTION OF PREFERRED EMBODIMENTS

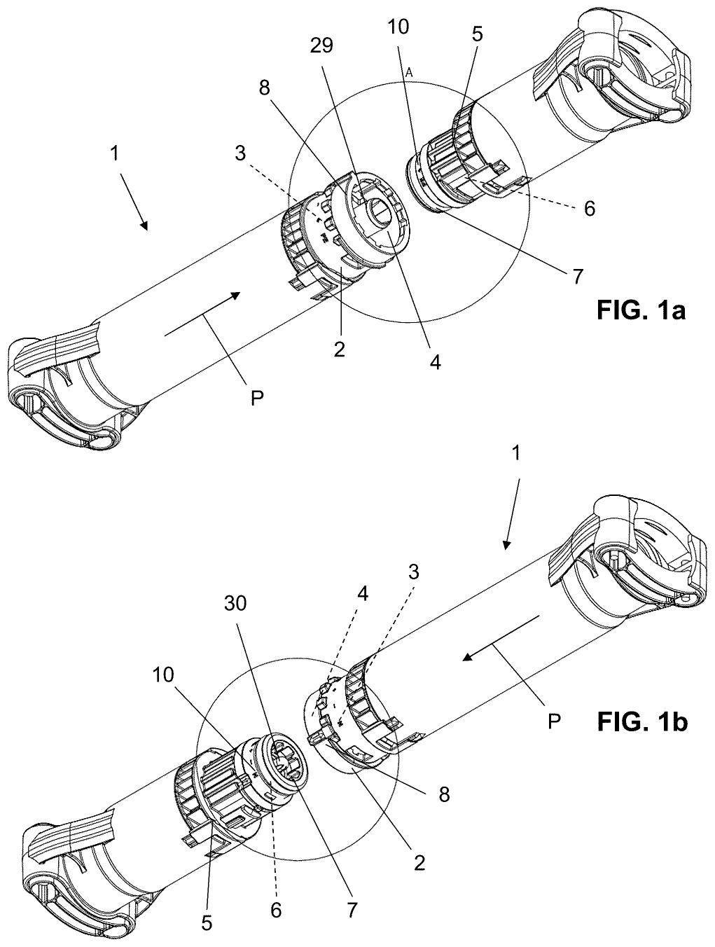

FIGS. 1a and 1b show a perspective view of the electrical connector assembly 1. The electrical connector assembly 1 comprises a first housing 2 and a second housing 5. The housings 2, 5 are connectable to each other along a plug-in direction P.

The first housing 2 defines a first interior space 3 in which at least one first electrical plug element 29 is arranged. Furthermore, the first housing 2 has a first connection portion 4. The second housing 5 defines a second interior space 6 in which at least one second electrical plug element 30 is arranged. Furthermore, the second housing 2 has a second connection portion 7.

When the first housing 2 is connected with the second housing 5, the first connection portion 4 and the second connection portion 7 engage with each other and an electrical contact is established between said at least one first electrical plug element 29 and said at least one second electrical plug element 30.

The first housing 2 has further a first coding ring 8 with a first coding element 9. The position of the first coding ring 8 with regard to the first housing 2 can be adjusted in at least two determined positions. This means that the first coding ring 8 can be positioned in a first determined position and in a second determined position. Optionally it can be positioned in further determined position.

The second housing 5 has further a second coding ring 10 with a second coding element 11. The position of the second coding ring 10 with regard to the second housing 5 can be adjusted in at least two determined positions. This means that the second coding ring 10 can be positioned in a first determined position and in a second determined position. Optionally it can be positioned in further determined position.

The first housing 2 and the second housing 5 are connectable only when the first coding ring 8 and the second coding ring 10 are located at the same determined position. A mating process will be successful in case both coding rings 8, 10 are at the first determined position. In case the first coding ring 8 is at first determined position and in the second coding ring is at the second position a mating process will not be possible.

In other words: The first housing 2 and the second housing 5 are not connectable with each when the first coding ring 8 and the second coding ring 10 are not located at the same determined position, or when the first coding ring 8 and the second coding ring 10 are located at the different determined positions, respectively.

The coding elements 9, 11 are provided such that the first coding element 9 engages with the second coding element 11 when the first housing 2 is connected to the second housing 5.

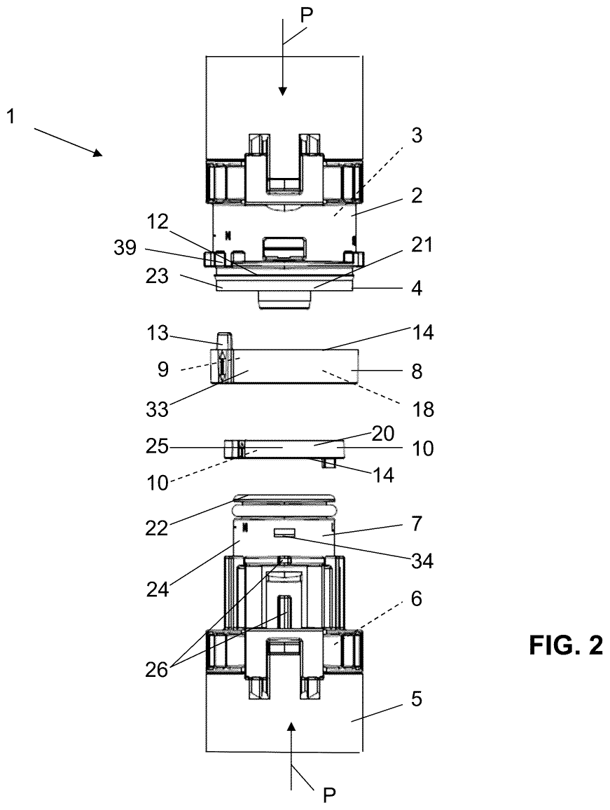

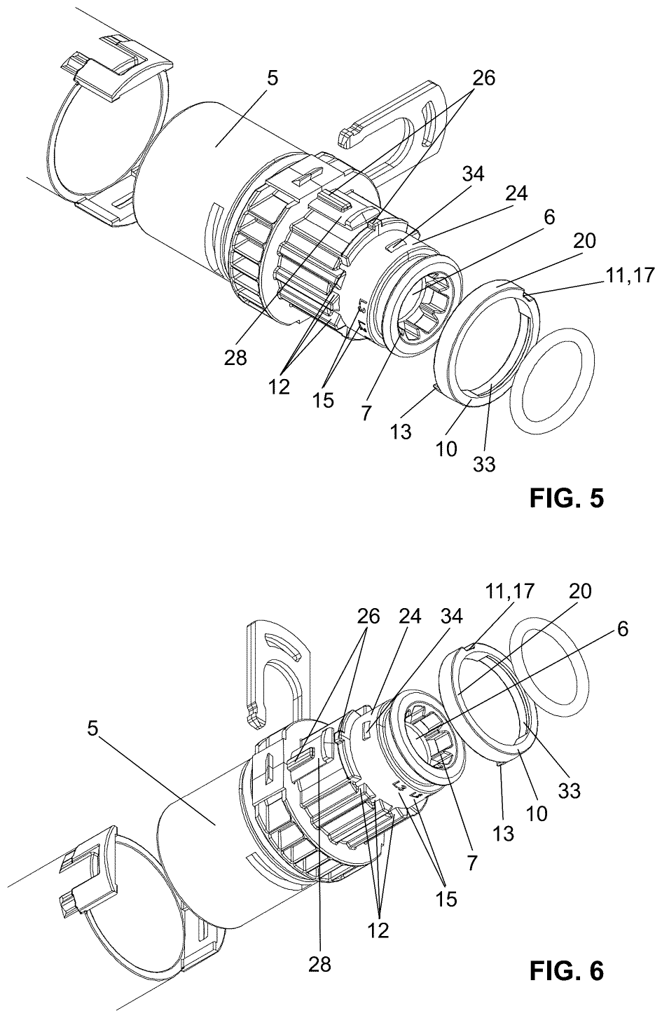

With FIGS. 2 to 8 the positioning of the coding rings 8, 10 on the housings 2, 5 will be outlined.

The above mentioned determined positions are provided by means at least two position grooves 12 into which at least one position notch 13 engages. Thereby at least two position grooves 12 are located on the first housing 2 and at least two position grooves 12 are located on the second housing 5. The position grooves 12 are integral parts of the respective housing 2, 5. The first coding ring 8 comprises at least one position notch 13. In the present case exactly one position notch 13 is arranged. The second coding ring 10 comprises also at least one position notch 13. In the present case exactly one position notch 13 is arranged. The position notches 13 on both coding rings 8, 10 are provided as integral parts of the coding rings 8, 10.

In other embodiments it may also be possible to arrange the position groove on the coding ring and the position notch on the housing.

As it can be seen from FIG. 2, the position grooves 12 and said position notch 13 are oriented such that the position notch 13 can be guided into one of said position grooves 12 along a longitudinal movement of the respective coding ring 8, 10 to the respective housing 2, 5. The longitudinal movement is thereby preferably parallel to the plug-in direction.

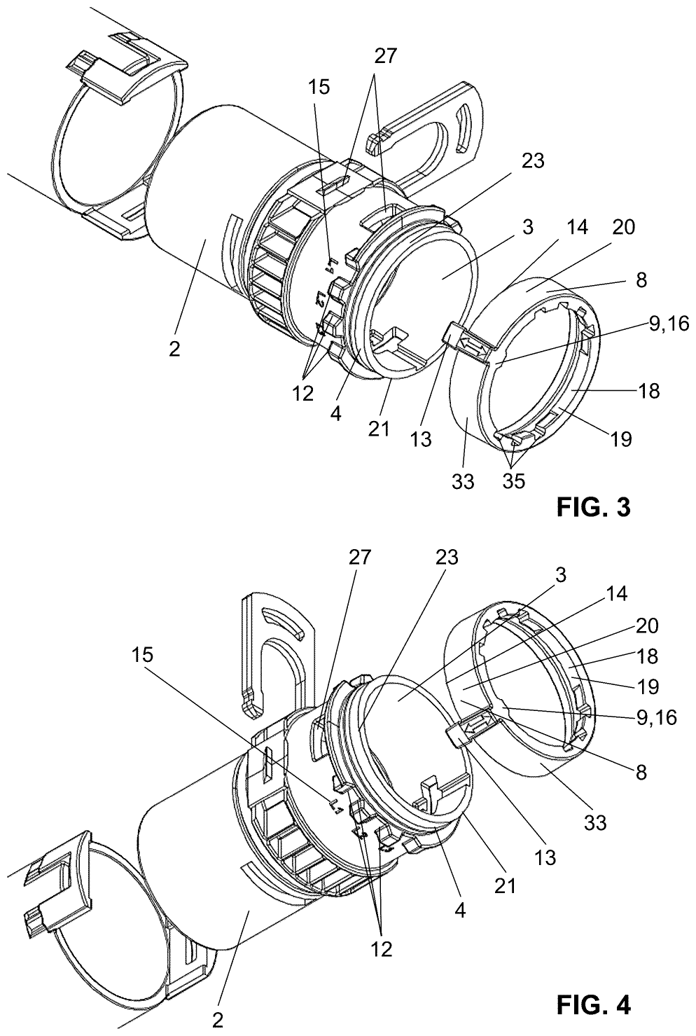

In FIGS. 3 to 8 the coding rings 8, 10 are shown in the unmounted state. The coding rings 8, 10 are to be oriented in the desired position and then moved towards the respective housing 2, 5 such that the position notch 13 engages into the position groove 12. FIGS. and the following figures show the mounted coding rings 8, 10.

In the embodiment shown, the shape and/or the position of the position groove 12 and the position notch 13 of the first housing 2 and the first coding ring 8 is different from the shape and/or the position of the position groove 12 and the position notch 13 of the second housing and the second coding ring 10. This prevents from a false mounting of the coding rings, in particular on the wrong housing.

The coding rings 8, 10 have a back face 14. The back face 14 of the first coding ring 8 is facing away from the second coding ring 10 and the back face 14 of the second coding ring is facing away from the first coding ring 8. The position notch 13 on the first coding ring 8 protrudes away from the back face 14 of the first coding ring 8 and the position notch 13 on the second coding ring 10 protrudes away from the back face 14 of the second coding ring 10.

The coding rings 8, 10 further have a front face 31. The front face 31 of the first coding ring 8 faces the front face 31 of the second coding ring 10. The front face 31 of both coding rings are provided as flush or even surfaces. The front face 31 runs preferably parallel to the back face 14.

Furthermore the coding rings 8, 10 comprises an inner side 18, 32 which encompasses a circular cylindrical ringspace 19, 25. On the outer side the coding rings 8, 10 comprises an outer side 20, 33.

In the present embodiment both, the first coding ring 8 and the second coding ring 10 are mechanically locked to the first housing 2 or the second housing 5, respectively. In the present case latching elements 34 are provided on the housings 2, 5 and/or on the coding rings 8, 10. The latching elements 34 are arranged such that once the position notch 13 engages fully into position groove 12 the respective coding ring 8, 10 is latched by means of the latching element 34 to the housing 2, 6.

As it can be seen from various figures, the determined positions are marked with a marking 15. The marking has preferably the shape of a letter and/or a number and/or a symbol and/or a combination thereof. The markings are provided on the respective housings 2, 5.

With reference to FIGS. 3 to 12 the coding element 9, 11 of the coding rings 8, 10 are explained in more detail. As mentioned above, the two housings 2, 5 are connectable together, in case the coding rings 8, 10 on both housings 2, 5 are at the same determined position. Thereby the coding elements 9, 11 match with each other and an engagement that allows the movement along the plug-in direction P becomes possible. In case the position of the coding rings 8, 10 is different, a connection will not be possible, as the coding elements 9, 11 will not match with each other and an engagement which would allow the movement along the plug in direction P is prevented.

In the present embodiment, the first coding ring 8 has a coding element 9 in the shape of a coding notch 16. The second coding ring 10 has a coding element 11 in the shape of a coding groove 17. The coding notch 16 and the coding groove 17 have complementary forms such that the coding notch 16 can slide into the coding groove 17. In the present case exactly one coding notch 16 is arranged on the first coding ring 10 and exactly one coding groove 17 is arranged on the second coding ring 11.

The coding notch 16 of the first coding ring 8 extends away from the inner side 18 of the first coding ring 8. The coding notch 16 thereby extends into the ringspace 25 of the first coding ring. The coding groove 17 of the second coding ring 9 extends from the outer side into the coding ring 9.

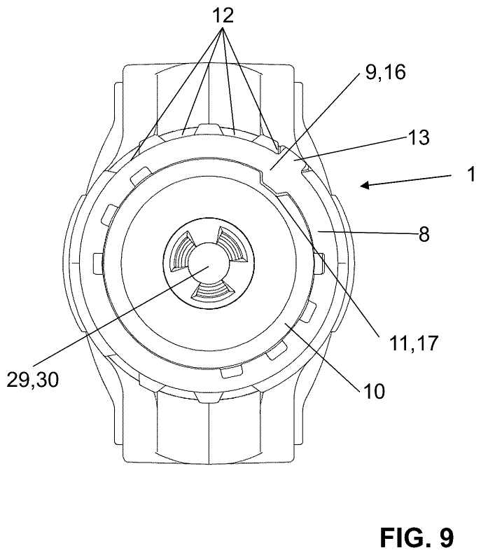

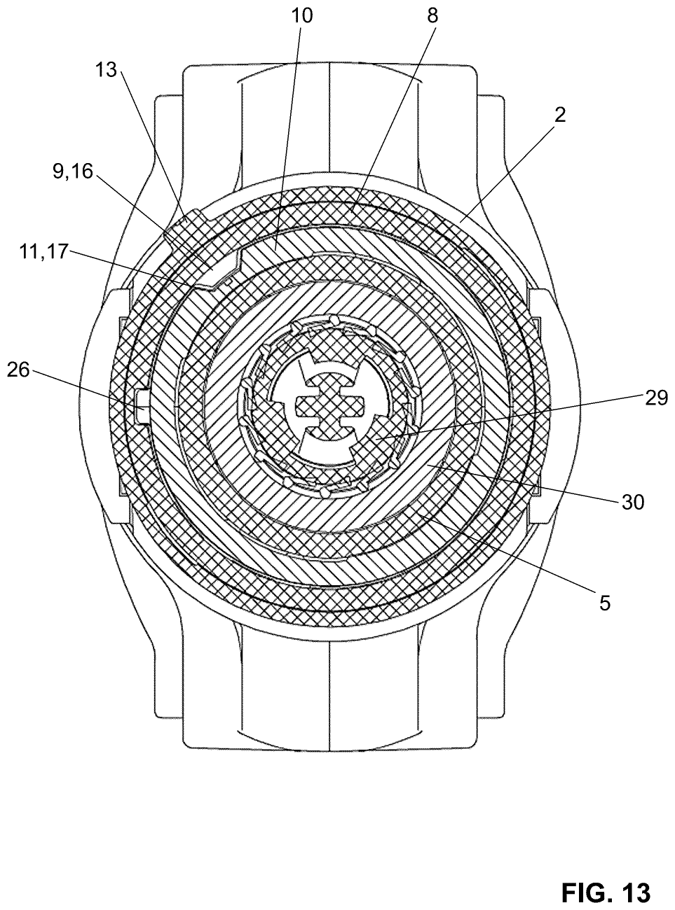

From the cross section of FIGS. 9 and 13 one is able to see that the cross section of the coding notch 16 and the cross section of the coding groove 17 are provided such that their cross section match with other.

From the cross section of FIGS. 9 and 13 it is further shown, that the second coding ring extends with its outer side 20 into the ringspace 19 of the first coding ring 8.

With FIGS. 3 to 9 the mounting of the first coding ring 8 and the second coding ring 10 will be explained. Said first coding ring 8 is mounted to a first mounting section 23 on the first housing 2. The ringspace 19 of said first coding ring 8 is in contact with said first mounting section 23. Said second coding ring 10 is mounted to a second mounting section 24 on the first housing 2, wherein the ringspace 25 of said second coding ring 10 is in contact with said second mounting section 24.

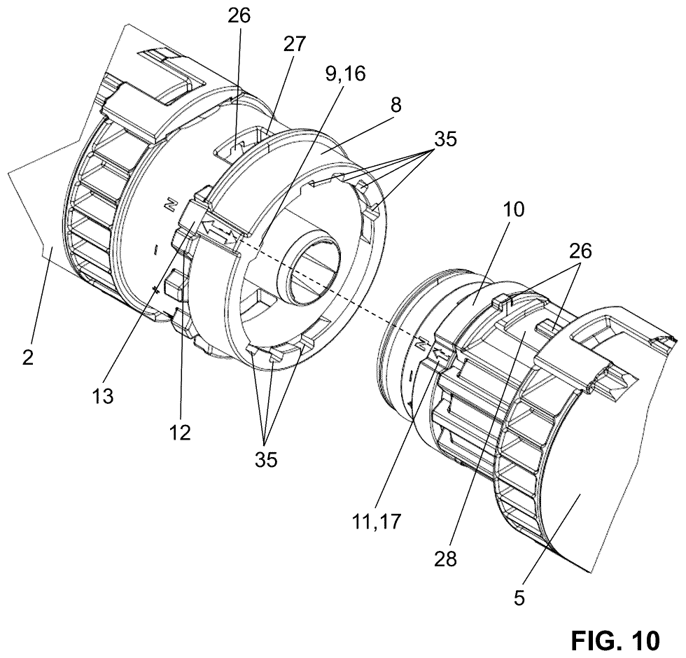

From FIG. 10 it becomes evident that the first housing 2 has a front face 21 and that said first coding element 9 is located before the front face 21 as seen in plug-in direction P. From FIG. 10 it becomes also visible how the first coding element 8 engages into the second coding element 11. This is shown by arrow A.

Preferably, said coding groove 17 and said coding notch 16 are oriented such that the coding notch 16 can be guided into one of said coding groove 17 along the plug-in direction.

With FIG. 12 a further coding structure is explained. Thereby the first connector housing 2 comprises a further coding element 26 and said second connector 5 housing comprises a further coding element 26. Said further coding elements 26 engage with each other when the first housing 2 is connected the second housing 5. The further coding element 26 on the first housing 2 is provided as coding groove and the further coding element 26 on the second housing 5 is provided as coding notch. Arrow B shows how the coding elements 26 engage with each other.

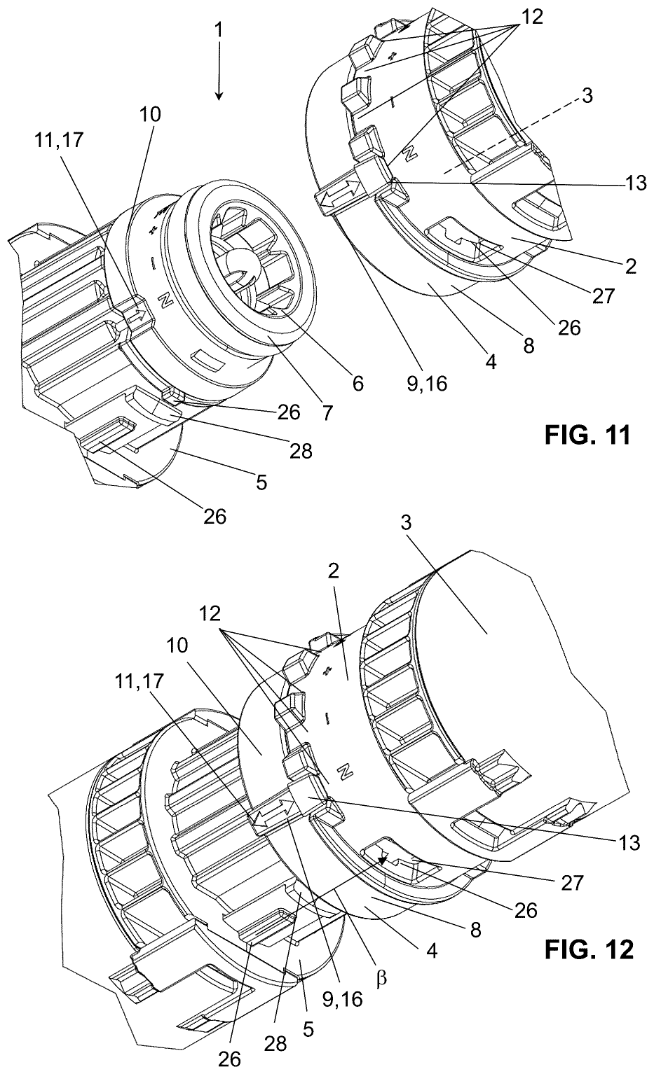

From FIGS. 11 and 12 the latching elements to mechanically fix the housings with each other are also shown. In the present embodiment said first connector housing 2 comprises at least one first latching element 27 and said second connector housing 5 comprises at least one second latching element 28. The at least one first latching element 27 engages with said at least one second latching element 28. The first latching element 27 is a latching opening and the second latching element 28 is a latching tab engaging in said latching opening.

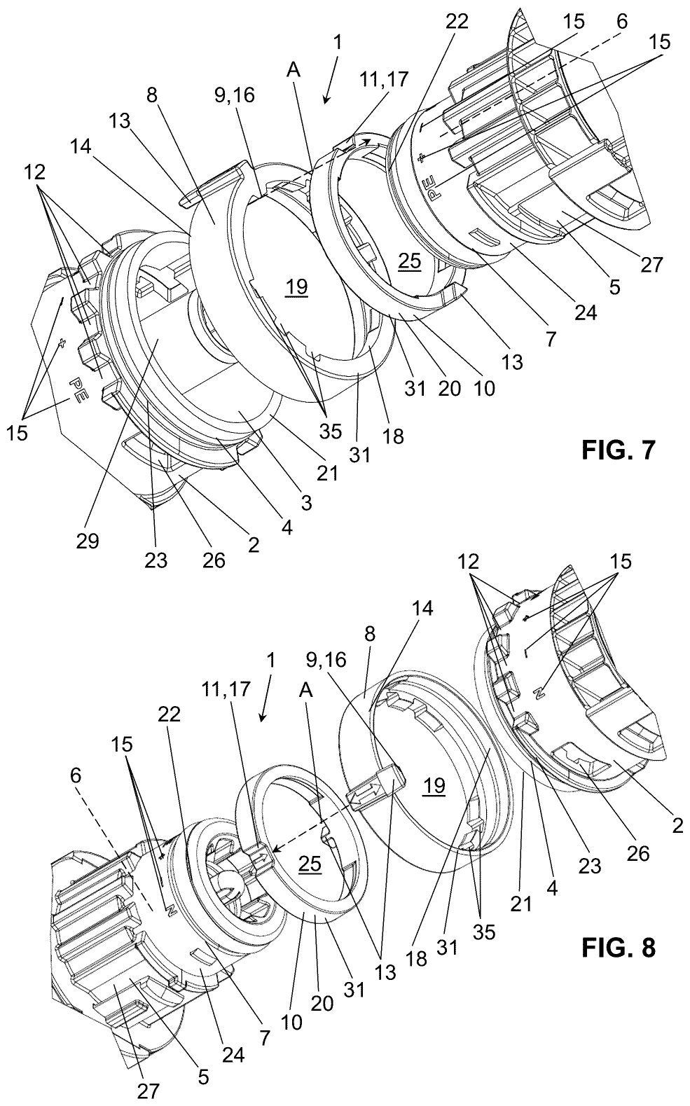

In the present embodiment said further coding elements 26 are part of the at least one first latching element 27 and of the at least one second latching element 28 as well as of the second housing. Reference is made to FIG. 11. As it can be seen from FIG. 7 for example, the first coding ring 8 comprises several cuts 35 which provide room for the further coding element 26 located on the other second housing.

From FIG. 13 it becomes evident that the further coding elements 26 are arranged on one of the two first latching element 27 and second latching element 28.

In the present embodiment said at least one first electrical plug element 29 is a pin and said at least one second electrical plug element 30 is a socket, wherein the pin engages into the socket.

LIST OF REFERENCE SIGNS

| | |
|---|---|
| 1 | connector assembly |
| 2 | first housing |
| 3 | first interior space |
| 4 | first connection portion |
| 5 | second housing |
| 6 | second interior space |
| 7 | second connection portion |
| 8 | first coding ring |
| 9 | first coding element |
| 10 | second coding ring |
| 11 | second coding element |
| 12 | position groove |
| 13 | position notch |
| 14 | back face |
| 15 | marking |
| 16 | coding notch |
| 17 | coding groove |
| 18 | inner side of first coding ring |
| 19 | ringspace of first coding ring |
| 20 | outer side of second coding ring |
| 21 | front face |
| 22 | front face |
| 23 | first mounting section |
| 24 | second mounting section |
| 25 | ringspace |
| 26 | further coding element |
| 27 | first latching element |
| 28 | second latching element |
| 29 | first electrical plug element |
| 30 | second electrical plug element |
| 31 | front face |
| 32 | inner side of the second coding ring |
| 33 | outer side of the first coding ring |
| 34 | latching element for coding rings |
| 35 | cut |
| A | arrow |
| B | arrow |
| P | plug in direction |

1-21. (canceled)

22. An electrical connector assembly comprising
a first housing defining a first interior space in which at least one first electrical plug element is arranged and having a first connection portion, and
a second housing defining a second interior space in which at least one second electrical plug element is arranged and having a second connection portion,
wherein the first housing is connectable with the second housing along a plug-in direction,
wherein when the first housing is connected with the second housing, the first connection portion and the second connection portion engage with each other and an electrical contact is established between said at least one first electrical plug element and said at least one second electrical plug element,
wherein the first housing has further a first coding ring with a first coding element, wherein the position of the first coding ring with regard to the first housing can be adjusted in at least two determined positions,
wherein the second housing has further a second coding ring with a second coding element, wherein the position of the second coding ring with regard to the second housing can be adjusted in at least two determined positions, and
wherein the first housing and the second housing are connectable only when the first coding ring and the second coding ring are located at the same determined position and wherein the first coding element engages with the second coding element when the first housing is connected to the second housing.

23. The connector assembly according to claim 22, wherein said determined positions are provided by means of at least two position grooves into which at least one position notch engages; or wherein said determined positions are provided by means of at least two position notches and at least one position groove into which the position notch engages.

24. The connector assembly according to claim 23, wherein said first housing comprises said at least two position grooves and wherein said first coding ring comprises said at least one position notch; and/or wherein said second housing comprises said at least two position grooves and wherein said second coding ring comprises said at least one position notch.

25. The connector assembly according to claim 23, wherein said position groove or position grooves, respectively and said position notch or position notches, respectively, are oriented such that the position notch can be guided into one of said position grooves along a longitudinal movement of the respective coding ring to the respective housing.

26. The connector assembly according to claim 25, wherein said first housing comprises said at least two position grooves and wherein said first coding ring comprises said at least one position notch; and/or wherein said second housing comprises said at least two position grooves and wherein said second coding ring comprises said at least one position notch.

27. The connector assembly according to claim 23, wherein the shape and/or the position of the position groove and the position notch of the first housing and the first coding ring is different from the shape and/or the position of the position groove and the position notch of the second housing and the second coding ring.

28. The connector assembly according to claim 23, wherein said position notch protrudes away from a back face of said coding rings.

29. The connector assembly according to claim 22, wherein said first coding ring is mechanically locked to said first housing and/or wherein said second coding ring is mechanically locked to said second housing.

30. The connector assembly according to claim 22, wherein said determined positions are marked with a marking, preferably in the shape of a letter and/or a number and/or a symbol and/or a combination thereof.

31. The connector assembly according to claim 22, wherein one of said coding rings comprises a coding notch as a respective coding element and wherein the other one of said coding rings comprises a coding groove as a respective coding element into which coding groove said coding notch engages when the first housing is connected to the second housing.

32. The connector assembly according to claim 22,
wherein said first coding element is a coding notch extending from the inner side of said first coding ring into the ringspace of said first coding ring and wherein said second coding element is a coding groove extending from the outer side into said second ring, wherein the coding notch and the coding groove have complementary forms such that the coding notch can be inserted into the coding groove; or
wherein said first coding element is a coding groove extending from the inner side of said first coding ring into said coding ring and wherein said second coding element is a coding notch extending from the outer side of said second coding ring, wherein the coding notch and the coding groove have complementary forms such that the coding notch can be inserted into the coding groove.

33. The connector assembly according to claim 22, wherein the second coding ring extends with its outer side into the ringspace of the first coding ring.

34. The connector assembly according to claim 22, wherein the first housing has a front face and wherein said first coding element is located before the front face as seen in plug-in direction and/or wherein the second housing has a front face and wherein said second coding element is located after the front face as seen in plug-in direction.

35. The connector assembly according to claim 22, wherein said first coding ring is mounted to a first mounting section on the first housing, wherein the ringspace of said first coding ring is in contact with said first mounting section; and/or wherein said second coding ring is mounted to a second mounting section on the second housing, wherein the ringspace of said second coding ring is in contact with said second mounting section.

36. The connector assembly according to claim 31, wherein said coding groove and said coding notch are oriented such that the coding notch can be guided into one of said coding groove along the plug-in direction.

37. The connector assembly according to claim 22, wherein said first connector housing comprises a further coding element and wherein said second connector housing comprises a further coding element, wherein said further coding elements engage with each other when the first housing is connected the second housing.

38. The connector assembly according to claim 37, wherein one of the coding rings comprise at least one cut through which at least one of said further coding element is guided during a mating process.

39. The connector assembly according to claim 22, wherein said first connector housing comprises at least one first latching element and wherein said second connector housing comprises at least one second latching element, wherein said at least one first latching element engages with said at least one second latching element.

40. The connector assembly according to claim 37, wherein said further coding elements are part of the at least one first latching element and/or of the first housing and of the at least one second latching element and/or of the second housing.

41. The connector assembly according to claim 22, wherein said at least one first electrical plug element is a socket and said at least one second electrical plug element is a pin, wherein the pin engages into the socket; or wherein said at least one first electrical plug element is a pin and said at least one second electrical plug element is a socket, wherein the pin engages into the socket.

42. The connector assembly according to claim 41, wherein said at least one first electrical plug element and/or said at least one second electrical plug element are directly mounted within the respective housing; or wherein said at least one first electrical plug element and/or said at least one second electrical plug element are mounted with a contact carrier element within the respective housing.

43. The connector assembly according to claim 22, wherein the first coding ring and/or the second coding ring are mechanically locked to the first housing or the second housing, respectively, wherein preferably latching elements are provided on the housings and/or on the coding rings.

44. The connector assembly according to claim 22, wherein the outer diameter of the circular cylinder surface section of the second coding ring is smaller than the inner diameter of the ringspace such that the circular cylinder surface section can extend into the ringspace.
